(19) United States
(12) Patent Application Publication
(10) Pub. No.: US 2017/0014855 A1
(43) Pub. Date: Jan. 19, 2017

(54) STACKED HOT MELT RESERVOIR AND METHODS OF ASSEMBLING SAME

(71) Applicants: Ryan R. Hopkins, Reno, NV (US); Vladimir Siroky, Bayside, NY (US)

(72) Inventors: Ryan R. Hopkins, Reno, NV (US); Vladimir Siroky, Bayside, NY (US)

(73) Assignee: MOLDMAN SYSTEMS LLC, Germantown, WI (US)

(21) Appl. No.: 14/800,310

(22) Filed: Jul. 15, 2015

(51) Int. Cl. B05C 11/10; F27B 14/06; H05B 3/62

(52) U.S. Cl. CPC B05C 11/1042; H05B 3/62; F27B 14/06

(57) ABSTRACT

A thermal reservoir including a melting section and a heating arrangement is provided. A method of assembling is also provided. The melting section includes a plurality of material flow sections. Each material flow section includes a central cavity extending axially therethrough between first and second ends along a central longitudinal axis. The plurality of material flow sections are operably removably connected together with the central cavities thereof aligned and in fluid communication to form a material flow path extending through all of the connected material flow sections. The heating arrangement cooperates with the plurality of material flow sections to provide heat for heating a material to be passed through the material flow path.

### FIELD OF THE INVENTION

This invention generally relates to molding machines for molding meltable materials such as hot melt adhesives and more particularly to thermal reservoirs for melting material for use in hot melt dispensers.

### BACKGROUND OF THE INVENTION

Many processes use hot melt type materials that are melted and then dispensed. For example, many molding processes use a hot melt dispenser to melt and dispense hot melt which is then molded to form a product. A wide range of materials having varying material properties for the multitude of different molded products exist. Unfortunately, some of the material properties that vary are the thermal properties. The thermal properties can differ widely. For instance material properties such as melting point, viscosity, and reaction to prolonged or excessive heat can vary widely from one material to another. More particularly, some materials are much more susceptible to degradation, such as char, if exposed to prolonged heating or excessive heating.

Further, different molding processes can use widely different rates of material.

Unfortunately, all of these variations from one molded product and the corresponding molding device and process to another molded product and the corresponding molding device and process can result in the need for a large number of material processing units such as molding machines and particularly melt reservoirs.

However, it can be costly to have a large number of different machines as there may be down time for a machine when a different product is being molded.

Embodiments of invention provide improvements over the current state of the art in molding machines and particularly in thermal reservoirs for molding machines.

### BRIEF SUMMARY OF THE INVENTION

Embodiments of the invention provide an assembler and designer of hot melt type molding machines to more accurately size the molding machine to the material being molded and the rate at which the material is being molded. More particularly, the assembler and designer of the molding machine can more accurately configure the thermal reservoir of the molding machine to correspond to the material capacity and thermal capacity needed by the thermal reservoir for a given material and product being molded.

In one embodiment, a thermal reservoir including a melting section and a heating arrangement is provided. The melting section includes a plurality of material flow sections. Each material flow section includes a central cavity extending axially therethrough between first and second ends along a central longitudinal axis. The plurality of material flow sections are operably removably connected together with the central cavities thereof aligned and in fluid communication to form a material flow path extending through all of the connected material flow sections. The heating arrangement cooperates with the plurality of material flow sections to provide heat for heating a material to be passed through the material flow path.

By providing a plurality of removably connected material flow sections, the quantity of material flow sections can be adjusted to modify the volumetric capacity and thermal capacity of the thermal reservoir.

In a particular embodiment, each material flow section is a finned unit including a plurality of fins extending radially relative to the longitudinal axis defining a plurality of angularly spaced apart cavity segments.

In a particular embodiment, an internal heat conduction unit is positioned within the central cavities of the connected plurality of material flow sections along the central longitudinal axis.

In a particular embodiment, the internal heat conduction unit is formed from a plurality of heat conduction segments connected together.

In a particular embodiment, the internal heat conduction segments are screwed together.

In a particular embodiment, the fins of the material flow sections are spaced radially outward from the internal heat conduction unit.

In a particular embodiment, the heating arrangement includes a plurality of heating elements with each heating element cooperating with a corresponding one of the plurality of material flow sections.

In a particular embodiment, the heating arrangement includes a heating element that overlaps an interface between adjacent material flow sections such that the heating element directly acts on at least two of the material flow sections.

In a particular embodiment, an unused material flow section that is not connected to the plurality of material flow units is provided. The unused material flow section could be connected to the plurality of material flow units to modify thermal and capacity characteristics of the melting section. This forms a type of kit that allows the assembly flexibility in the configuration of the thermal reservoir.

In a particular embodiment, at least one connector extends through holes extending axially entirely through the plurality of finned units to connect the plurality of finned units in a stack. The connector is removable such that the thermal reservoir can be reconfigured.

In a particular embodiment, at least one dowel pin engages adjacent ones of the plurality of finned units to align the adjacent finned units, the connector being threaded.

In a particular embodiment, the finned units are identical.

In a particular embodiment, for each finned unit, the first end includes an annular groove that surrounds the central cavity and the second end defines a seal surface at a same radial location relative to the central longitudinal axis as the annular groove. The embodiment also includes a gasket located within a groove of one of two adjacent finned units forming an interface therebetween and the gasket contacts a seal surface of the other one of the two adjacent finned units to form a seal therebetween.

In one embodiment, a melting section for a thermal reservoir is provided. The melting section includes a plurality of material flow sections. Each material flow section includes a central cavity extending axially therethrough between first and second ends along a central longitudinal axis. The plurality of material flow sections are removably connectable together such that the central cavities thereof align in fluid communication to form a material flow path extending through all of the material flow sections when connected.

In a particular embodiment, each material flow section is a finned unit including a plurality of fins extending radially relative to the longitudinal axis defining a plurality of angularly spaced apart cavity segments.

In a particular embodiment, the finned units are identical.

In a particular embodiment, for each finned unit, the first end includes an annular groove that surrounds the central cavity and the second end defines a seal surface at a same radial location relative to the central longitudinal axis as the annular groove.

In another embodiment, a method of assembling a thermal reservoir is provided. The method includes selecting at least one of a desired thermal or volumetric capacity of the thermal reservoir. The method includes selecting a quantity of a plurality of material flow sections that meets to the selected desired thermal or volumetric capacity. Each material flow section includes a central cavity extending axially therethrough between first and second ends along a central longitudinal axis. The method includes connecting the plurality of material flow sections with the central cavities thereof aligned and in fluid communication to form a material flow path extending through all of the connected material flow sections. The method includes supplying a heating arrangement cooperating with the plurality of material flow sections to provide heat for heating a material to be passed through the material flow path.

In a particular embodiment, each material flow section is a finned unit including a plurality of fins extending radially relative to the longitudinal axis defining a plurality of angularly spaced apart cavity segments.

In a particular embodiment, the method includes mounting an internal heat conduction unit positioned within the central cavities of the connected plurality of material flow sections along the central longitudinal axis.

In a particular embodiment, the step of mounting an internal heat conduction unit includes selecting a quantity of internal heat conduction unit segments such that the internal heat conduction unit has a length that corresponds to the length of the material flow path formed by the connected material flow sections.

In a particular embodiment, supplying a heating arrangement includes supplying a plurality of heating elements with each heating element cooperating with a corresponding one of the plurality of material flow sections.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a profile illustration of an embodiment of a thermal reservoir according to the invention;

FIG. 2 is a cross-sectional illustration of the thermal reservoir of FIG. 1;

FIG. 3 is a perspective exploded illustration of the thermal reservoir of FIG. 1;

FIG. 4 is a side exploded illustration of the thermal reservoir of FIG. 1;

FIG. 5 is a top perspective illustration of a finned unit of the thermal reservoir of FIG. 1;

FIG. 6 is a bottom perspective illustration of the finned unit of FIG. 5; and

FIG. 7 is a perspective illustration of a connector section of the thermal reservoir of FIG. 1.

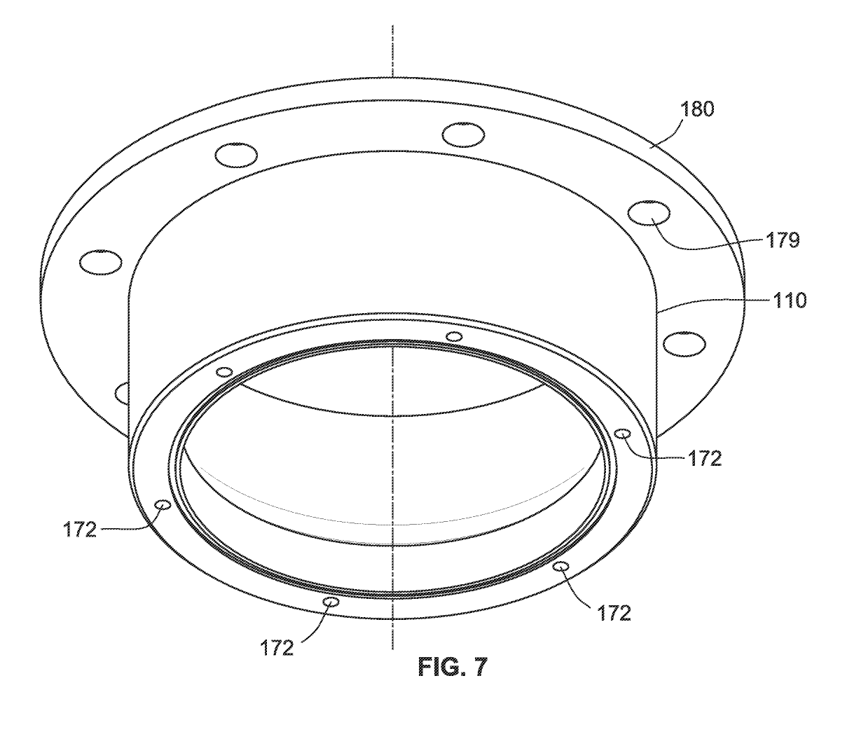

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

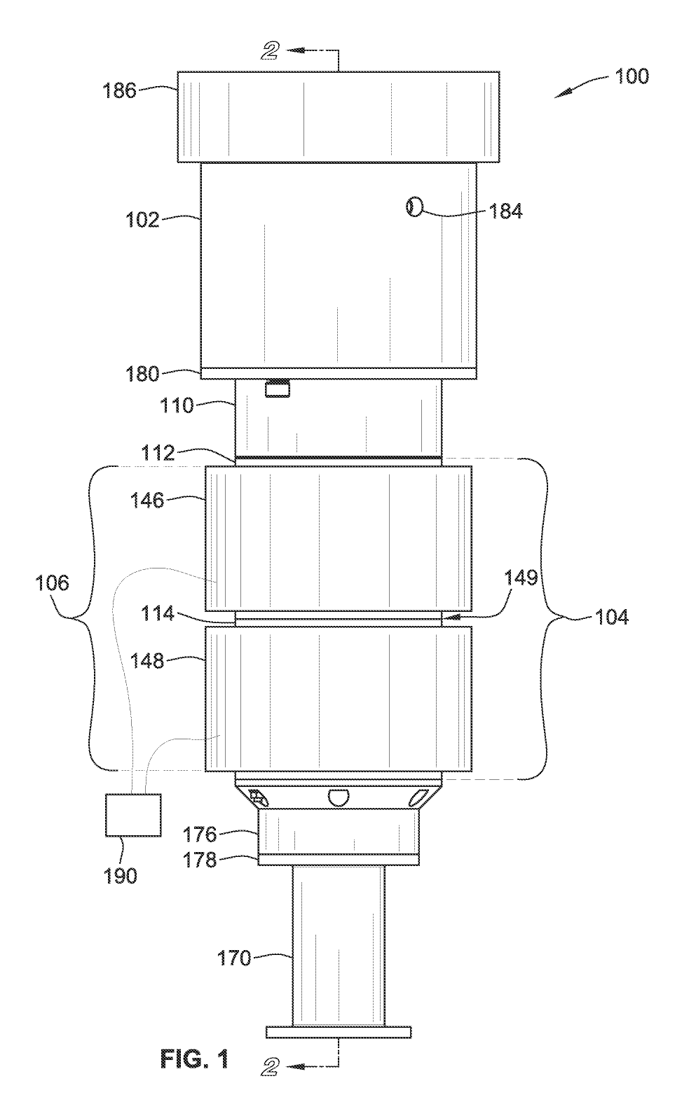

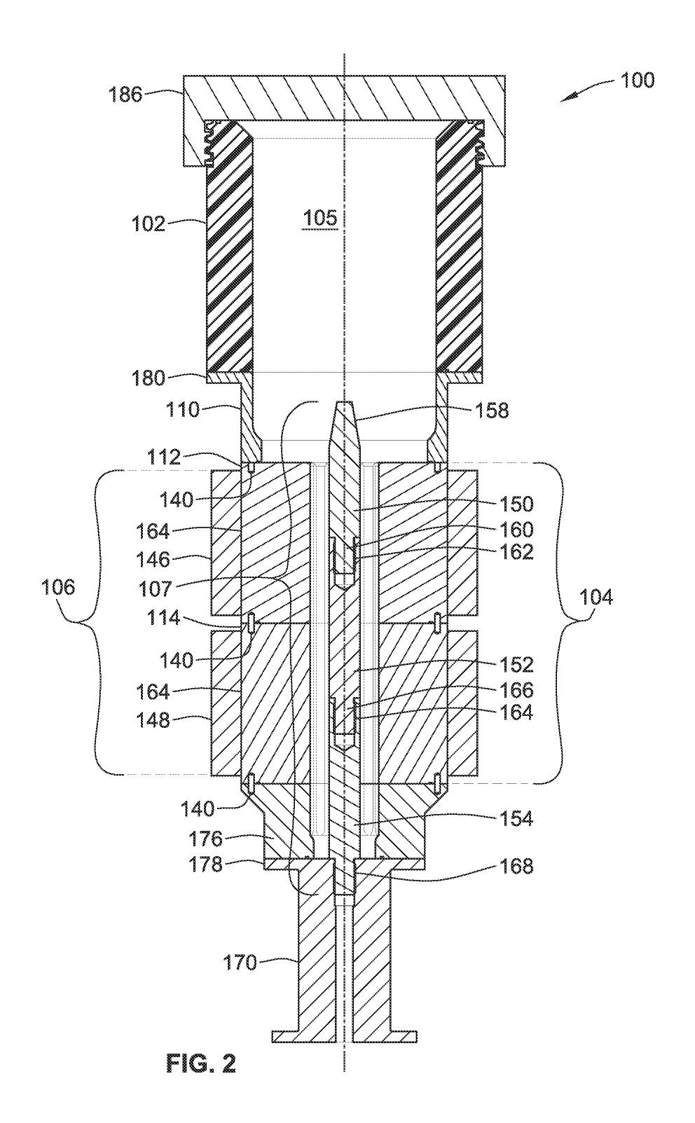

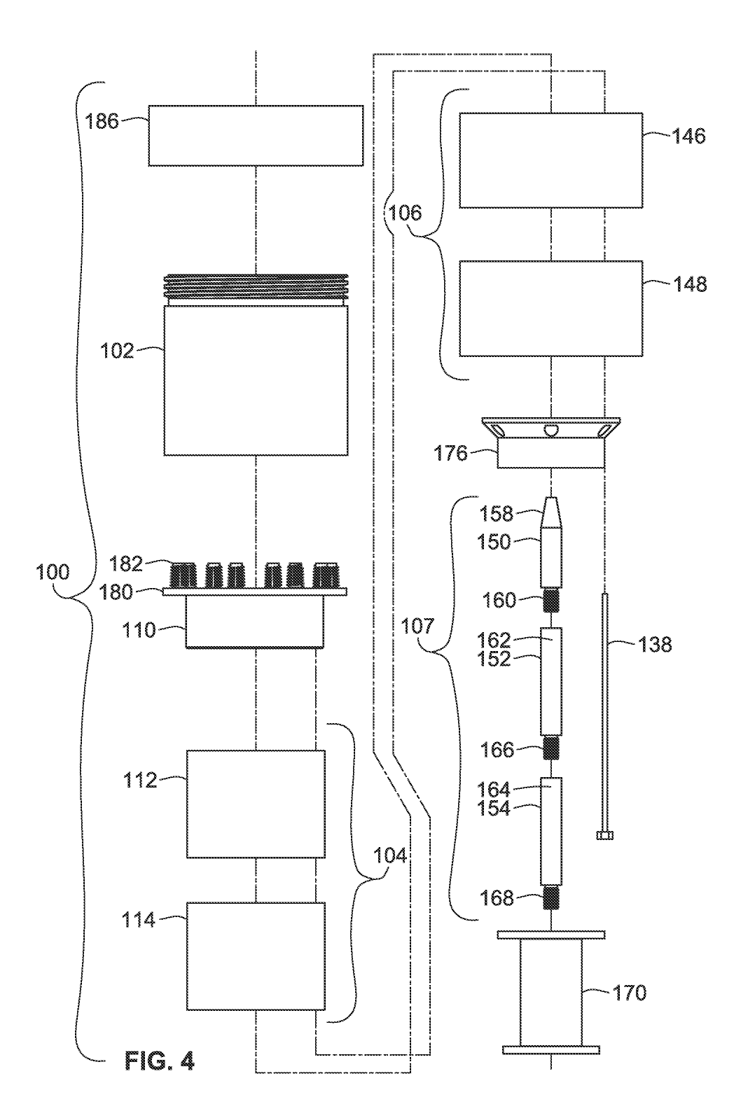

FIGS. 1-4 illustrate an improved thermal reservoir 100 for use in molding apparatuses and particularly molding apparatuses that mold using hot melt material. Such a molding apparatus may also be referred to as a hot melt material processor. The thermal reservoir 100 includes an upper section 102 (also referred to an extension section 102) and a lower melting section 104 (also referred to as a finned portion 104). The thermal reservoir 100 may be used in other systems or hot melt dispensing machines.

Hot melt material to be molded will enter the thermal reservoir 100 through the upper section 102. The upper section 102 defines an internal storage cavity 105 for storing large amounts of hot melt material in powder/granular form to be melted.

Hot melt material in powder/granular form will be heated and melted in the finned portion 104 by a heater arrangement 106 adjacent to or integrated into the finned portion 104 in conjunction with an internal heat conduction unit 107 located within a cavity of the finned portion 104.

The heater arrangement 106 is illustrated in simplified schematic form attached to the outer peripheral surface of the finned portion 104. In some embodiments, the heater arrangement 106 may by tubular and surround a portion of the finned portion 104. In alternative embodiments, the heater arrangement may be integrated into the sidewalls of the finned portion 104.

The finned portion 104 may include a plurality of fins or flow passages that form webs of material to increase the surface area that is exposed to the hot melt material to increase the melting efficiency and uniformity of the thermal reservoir 100.

Typically, the volume for holding hot melt material and structure of finned portion 104 and heater arrangement 106 are configured such that the finned portion 104 will hold the desired amount of material within the finned portion 104. The size and configuration of the finned portion 104 will be such that the heater arrangement 106 will provide the correct amount of heat to the finned portion 104 to melt the amount of hot melt material per unit of time.

A connector section 110, also referred to as an adaptor plate, connects upper section 102 to the finned portion 104.

To accommodate different melt rates and melt capacities needed for a particular material application, the finned portion 104 is formed from a plurality of material flow section removably connected together through which the material flows as it is heated and melted. The material flow sections are illustrated in the form of stackable finned units 112, 114. While the illustrated embodiment includes two finned units 112, 114, it will be readily apparent that more than or less than two finned units may be used in other embodiments or configurations.

The finned units 112, 114 are identical to one another.

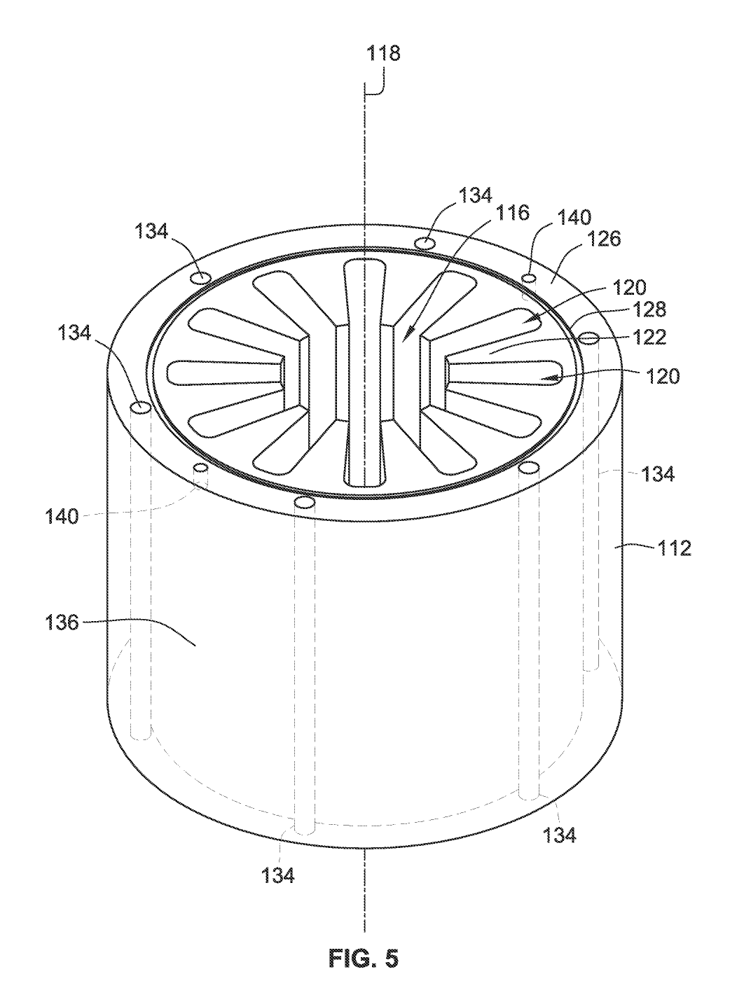

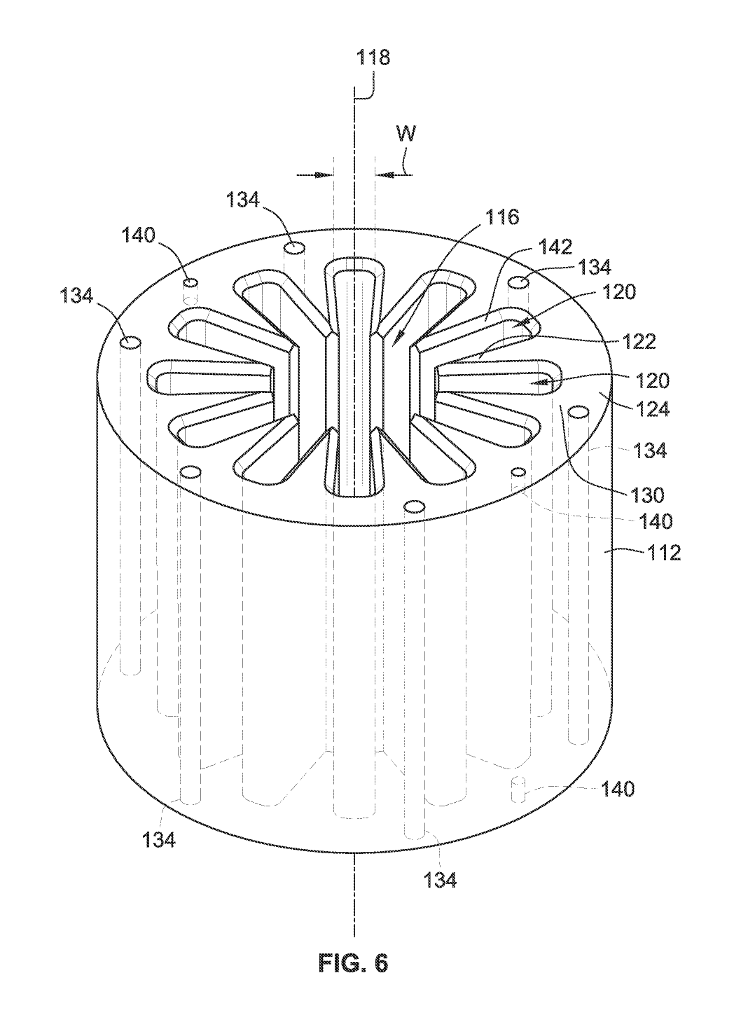

With reference to FIGS. 5 and 6, a single stackable finned unit 112 is illustrated. Each stackable finned unit 112 defines a central cavity 116 extending axially therethrough along a central longitudinal axis 118 thereof. The central cavity 116 includes a plurality of segments 120 that are separated from a plurality of radially extending fin sections 122 of the finned unit 112. The material to be melted will pass axially through the central cavity 116 as it passes through the finned portion 104. By segmenting the central cavity 116, more surface are is provided that can come in contact with the material to be heated to provide more uniform heat distribution and more uniform heating of the material to be melted.

The fin sections 122 are generally pie-shaped such that the width W of a given segment 120 of the central cavity 116 remains substantially constant when moving in the radial direction. This again, promotes uniform melting of the material.

The stackable finned unit 112 extends axially between first and second ends 124, 126. The second end 126 in the illustrated embodiment includes an annular groove 128 for receipt of a seal, such as a gasket or o-ring. The opposite first end 124 has a smooth seal surface 130 in a same radial position as the annular groove 128 against which the seal carried by an adjacent component, such as an adjacent second stackable finned unit 114, will seat at the interface therebetween.

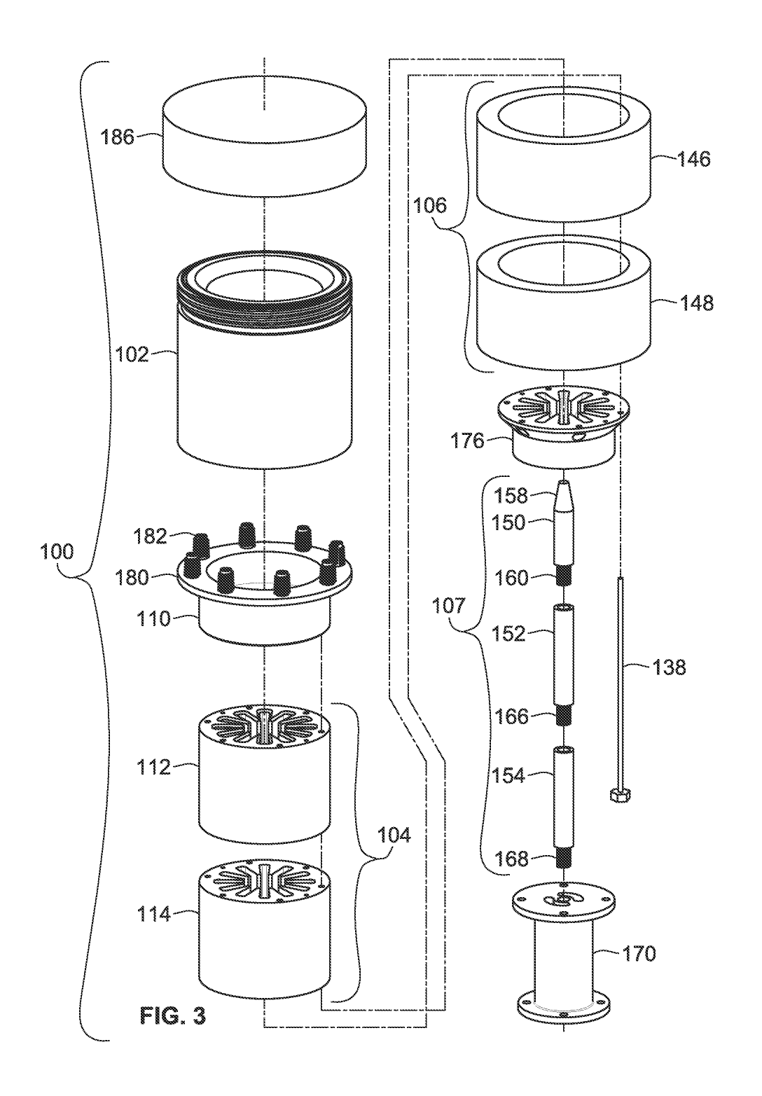

Radially outward of the annular groove 128 and seal surface 130 are a plurality of through holes 134 that extend the entire axial length of the body 136 of the stackable finned unit 112. The through holes 134 are sized to receive connectors 138 (see e.g. FIG. 3, only one shown) such as threaded rods or bolts for securing adjacent components together. The connectors 138 will put the adjacent stackable finned units 112, 114 in a state of compression with sufficient force to prevent material leakage.

Additionally, a pair of dowel pin locating holes 140 are located in each end 124, 126. Dowel pins (not shown) can be located in the dowel pin locating holes for aligning adjacent components during assembly and prior to tightening of connectors 138.

In the illustrated embodiment, the first end 124 will be an inlet end and the second end 126 will be an outlet end. In this embodiment, the edges of the fin sections 122 at the first end 124 have a chamfer 142.

Preferably, the finned units 112, 114 are identical.

In the illustrated embodiment, the heating arrangement includes a heating element 146, 148 for each of the finned units 112, 114. This allows for more precise heating of the material as it is being melted as it passes through the finned portion 104. The heating elements 146, 148 are band style heating elements that surround, at least a portion of, the outer peripheral surface of the finned units 112, 114. In other embodiments, a single heating element can extend the entire length of the finned portion 104. In such an embodiment, the single heating element could overlap an interface 149 between adjacent finned units 112, 114 and direct act on and heat multiple finned units 112, 114.

By providing multiple stackable finned units 112, 114 and multiple heating elements 146, 148, more controlled temperature and capacity can be provided for better tailoring the thermal reservoir 100 to the material being melted.

The thermal reservoir 100 includes an internal heat conduction unit 107. The internal heat conduction unit 107 further increases the surface area for heating the material and also makes the flow passage through the thermal reservoir 100 more uniform in thickness for more uniform melting of the material. In the illustrated embodiment, the internal heat conduction unit 107 is centered on the central axis 118 of the finned portion 104.

Further, the internal heat conduction unit 107 is formed from a plurality of segments that screw together including a head segment 150, an intermediate segment 152 and a tail base segment 154. The intermediate segment is interposed between the head segment 150 and tail segment 154. In this embodiment, the intermediate segment 152 is identical to the tail segment 154. By providing multiple segments 150, 152, 154 the length of the internal heat conduction unit 107 can be tailored to the overall length of the finned portion 104 based on the number of finned units 112, 114.

The head segment 150, intermediate segment 152 and tail segment 154 are threadedly connected such that heat can be transferred therebetween. The head segment 150 has a tapered or conical lead end 158 and a male threaded opposed end 160. The intermediate segment 152 and tail segment 154 have a female threaded end 162, 164 and an opposed male threaded end 166, 164 for interconnecting the components.

The tail segment 154 threadedly connects to and is supported by lower tube 170.

The connector section 110 includes a plurality of threaded holes 172 that will align with through holes 134. The connector 138 will thread into threaded holes 172 to secure the components of the thermal reservoir 100 in compression. The connector section 110 may be configured to inhibit heat transfer from the heating arrangement 106 to the upper section 102 to inhibit char of the un-melted material stored therein. This can be accomplished by reducing wall thicknesses of the tubular wall portion of the connector section 110 or forming the connector section from thermal insulating materials or placing thermal insulating materials or gaskets between connector section 110 and upper section 102 and/or between connector section 110 and the upper most finned unit 112.

A second connector section 176 is interposed between lower tube 170 and the opposite end of the finned portion 104 as connector section 110. The second connector section 176 includes a plurality of through holes that align with through holes 134 in the finned units 112, 114 through which the connectors 138 extend. A head of the connectors 138 will be sized larger than the diameter of the through holes in the second connector section 176 so that tightening of the connectors will place the components in compression.

The second connector section 176 is connected to the lower tube 170 by bolts (not shown) that pass through flange 178 and thread into a distal end of the second connector section 176.

The first connector section 110 is similarly connected to upper section 102 by bolts 182 that pass through holes 179 in flange 180. In an embodiment, the upper section 102 is made from a non-stick insulated material. In some embodiments, the non-stick insulated material is softer or weaker and threaded inserts 182 may be embedded therein to receive the bolts.

The upper section 102 may include a port 184 through which nitrogen or other fluid can be supplied to provide internal pressure within the upper section 102 as well as to inhibit oxidation of the material stored therein. Further, a cover 186 may be threaded or otherwise attached to an open end of the upper section 102.

To prevent char and sticking of material that is being processed by the thermal reservoir 100, various components, in addition to the upper section 102, may be coated with non-stick material such as PTFE (polytetraflouroethylene). More particularly, the surfaces of the components that come in contact with the material that is being melted may have such a coating. The coating will occur prior to assembly.

A controller 190 may be operably connected to the heating elements 146, 148 to control the power supplied to each of the heating elements. Further, the controller 190 may be configured to control multiple heating elements or individual controllers may be provided for each heating element. While not shown, a heating element will also be provided for the internal heat conduction unit 107. The controller 190 may be connected thereto and control the power supplied thereto to control the amount of heat provided by the heat conduction unit 107.

Methods of configuring a thermal reservoir 100 are also provided. Methods will include selecting a desired quantity of stackable finned units 112, 114 to assemble so as to provide a desired volume for internal cavity 116 as well as configuring the corresponding heating element(s) 146, 148 so as to provide desired melting of the material passing through the internal cavity 116. Selecting the desired quantity of stackable finned units 112, 114 matching the capacity and thermal needs to the consumption rate of the material. This matching allows the machine to be optimized to further reduce or eliminate material degradation due to unnecessary prolonged exposure to high temperatures.

The flexibility of the thermal reservoir allows the designer and assembler the ability to customize the amount of heat that can be applied to the material so as to achieve a thermal melt on demand system. By matching the amount of energy introduced into the reservoir to the capacity and consumption rate of the material within the unit, a thermal melt on demand system can be quickly designed and assembled.

Further, many units will use welds to secure various different portions of the thermal reservoir together. However, by using a bolt together design of the stacked reservoir, uneven surfaces between different components, and particularly adjacent stacked finned units, are eliminated.

This system allows for multiple sizes of heater bands to be added to the system. The system can, as noted above, utilize heater bands that fit within the axial length of each finned unit 112, 114 or it can utilize a single heater band that spans all, or most of, the length of the stacked finned units 112, 114. By matching the capacity and thermal characteristics/outputs of the system to the consumption rate of the material being melted, the thermal reservoir can be optimized to reduce or eliminate material degradation due to prolonged exposure to high or incorrect temperatures.

This system allows the assembler to have a few extra components on hand for assembly and reconfiguration of a system configured to produce different melt rates and material capacities while only needing to add or subtract a few components without needing a whole new system. Such extra components could be additional finned units 112, 114, different length connectors 138 to accommodate for different height stacks, additional internal heat conduction unit segments, additional heating elements and/or different sized heating elements.

What is claimed is:

1. A thermal reservoir comprising:
a melting section including:
a plurality of material flow sections, each material flow section including a central cavity extending axially therethrough between first and second ends along a central longitudinal axis, the plurality of material flow sections being operably removably connected together with the central cavities thereof aligned and in fluid communication to form a material flow path extending through all of the connected material flow sections; and
a heating arrangement cooperating with the plurality of material flow sections to provide heat for heating a material to be passed through the material flow path.

2. The thermal reservoir of claim 1, wherein each material flow section is a finned unit including a plurality of fins extending radially relative to the longitudinal axis defining a plurality of angularly spaced apart cavity segments.

3. The thermal reservoir of claim 1, further including an internal heat conduction unit positioned within the central cavities of the connected plurality of material flow sections along the central longitudinal axis.

4. The thermal reservoir of claim 3, wherein the internal heat conduction unit is formed from a plurality of heat conduction segments connected together.

5. The thermal reservoir of claim 4, wherein the internal heat conduction segments are screwed together.

6. The thermal reservoir of claim 2, further including an internal heat conduction unit positioned within the central cavities of the connected plurality of material flow sections along the central longitudinal axis, wherein the fins of the material flow sections are spaced radially outward from the internal heat conduction unit.

7. The thermal reservoir of claim 1, wherein the heating arrangement includes a plurality of heating elements, each heating element cooperating with a corresponding one of the plurality of material flow sections.

8. The thermal reservoir of claim 1, wherein the heating arrangement includes a heating element that overlaps an interface between adjacent material flow sections such that the heating element directly acts on at least two of the material flow sections.

9. The thermal reservoir of claim 1, further comprising an unused material flow section that is not connected to the plurality of material flow units but that could be connected to the plurality of material flow units to modify thermal and capacity characteristics of the melting section.

10. The thermal reservoir of claim 2, further including at least one connector extending through holes extending axially entirely through the plurality of finned units to connect the plurality of finned units in a stack.

11. The thermal reservoir of claim 11, further including at least one dowel pin engaging adjacent ones of the plurality of finned units to align the adjacent finned units, the connector being threaded.

12. The thermal reservoir of claim 2, wherein the finned units are identical.

13. The thermal reservoir of claim 1, wherein, for each finned unit, the first end includes an annular groove that surrounds the central cavity and the second end defines a seal surface at a same radial location relative to the central longitudinal axis as the annular groove;
further including a gasket located within a groove of one of two adjacent finned units forming an interface therebetween and the gasket contacting a seal surface of the other one of the two adjacent finned units to form a seal therebetween.

14. A melting section for a thermal reservoir comprising a plurality of material flow sections, each material flow section including a central cavity extending axially therethrough between first and second ends along a central longitudinal axis, the plurality of material flow sections being operably removably connectable together with the central cavities thereof aligned and in fluid communication to form a material flow path extending through all of the connected material flow sections.

15. The melting section of claim 14, wherein each material flow section is a finned unit including a plurality of fins extending radially relative to the longitudinal axis defining a plurality of angularly spaced apart cavity segments.

16. The melting section of claim 15, wherein the finned units are identical.

17. The melting section of claim 15, wherein, for each finned unit, the first end includes an annular groove that surrounds the central cavity and the second end defines a seal surface at a same radial location relative to the central longitudinal axis as the annular groove.

18. A method of assembling a thermal reservoir comprising:
selecting at least one of a desired thermal or volumetric capacity of the thermal reservoir;
selecting a quantity of a plurality of material flow sections to meet the selected desired thermal or volumetric capacity, each material flow section including a central cavity extending axially therethrough between first and second ends along a central longitudinal axis;
connecting, removably, the plurality of material flow sections with the central cavities thereof aligned and in fluid communication to form a material flow path extending through all of the connected material flow sections; and
supplying a heating arrangement cooperating with the plurality of material flow sections to provide heat for heating a material to be passed through the material flow path.

19. The method of claim 18, wherein each material flow section is a finned unit including a plurality of fins extending radially relative to the longitudinal axis defining a plurality of angularly spaced apart cavity segments.

20. The method of claim 18, further including mounting an internal heat conduction unit positioned within the central cavities of the connected plurality of material flow sections along the central longitudinal axis.

21. The method of claim 20, wherein the step of mounting an internal heat conduction unit includes selecting a quantity of internal heat conduction unit segments such that the internal heat conduction unit has a length that corresponds to the length of the material flow path formed by the connected material flow sections.

22. The method of claim 18, wherein supplying a heating arrangement includes supplying a plurality of heating elements, each heating element cooperating with a corresponding one of the plurality of material flow sections.
